(19) United States
(12) Patent Application Publication
(10) Pub. No.: US 2005/0275128 A1
(43) Pub. Date: Dec. 15, 2005

(54) Method for manufacturing environment friendly foam material for shoes

(76) Inventors: Li-Chen Hsiao, Yongjing Township (TW); Chien-Chang Lin, Chiayi City (TW); Hui-Ling Wang, Lugang Township (TW); Peng-Yi Kuo, Minsyong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/866,740

(22) Filed: Jun. 15, 2004

(51) Int. Cl. B29C 44/02

(52) U.S. Cl. 264/51

(57) ABSTRACT

A method for manufacturing foam material for shoes includes the steps of acquiring coconut shells, crushing the coconut shells into small pieces, grinding the coconut shell pieces into coconut fiber powder, mixing the coconut fiber powder with glue as well as foaming material, making the mixture of the coconut fiber powder and the foaming material foam in molds, and finishing, in which the foam mixture are cut into insoles of shoes after having been taken out of the molds, and in which middle soles and outsoles of shoes are directly formed in those the molds that are used for making middle soles and outsoles.

### BACKGROUND OF THE INVENTION

1. Field of the Invention

The present invention relates to a method for manufacturing foam material for shoes, more particularly one, with which the shoe products will have better ventilation, more elasticity, and resilience, and can prevent dampness and fungus, and will be easier to burn, and decompose.

2. Brief Description of the Prior Art

Referring to FIGS. 4 and 5, a conventional method for making insoles of shoes includes the steps of mixing resin and foaming material, making the mixture foam in molds to become a foam material 8, and cutting the foam material 8 into separate insoles 81.

Thus, the soles 81 have certain softness and elasticity, which will make the wearers of the shoes with the insoles 81 feel comfortable. However, because the insoles 81 are made of such foam material, the shoes with the soles 81 have poor ventilation, and dampness and fungus are prone to form in the shoes. Consequently, the wearers will have bad odors and skin diseases on their feet owing to wearing the shoes for long time in hot weather. Furthermore, such foam material can't be burned or decomposed therefore they will cause problems to environmental protection.

### SUMMARY

It is a main object of the present invention to provide a method for manufacturing foam material for shoes to overcome the above disadvantages.

The method of the present invention includes the steps of acquiring coconut shells, crushing the coconut shells into small pieces, grinding the coconut shell pieces into coconut fiber powder, mixing the coconut fiber powder with glue as well as foaming material, making the mixture of the coconut fiber powder and the foaming material foam in molds, and finishing, in which the foam mixture are cut into insoles of shoes after having been taken out of the molds, and in which middle soles and outsoles of shoes are directly formed in the molds. The shoe products will have better ventilation, more elasticity, and resilience, and can prevent dampness and fungus, and will be easier to burn, and decompose there are environment friendly.

### BRIEF DESCRIPTION OF THE DRAWINGS

The present invention will be better understood by referring to the accompanying drawings, wherein:

FIG. 1 is a flow chart of the method for manufacturing foam material for shoes according to the present invention,

FIG. 2 is a vertical section of a foam material for shoes made according to the method of the present invention,

FIG. 3 is a view of a shoe, showing the use of the foam material of the present invention,

FIG. 4 is a flow chart of the method for making conventional foam material for shoes, and

FIG. 5 is a vertical section of the conventional foam material.

### DETAILED DESCRIPTION OF THE PREFERRED EMBODIMENTS

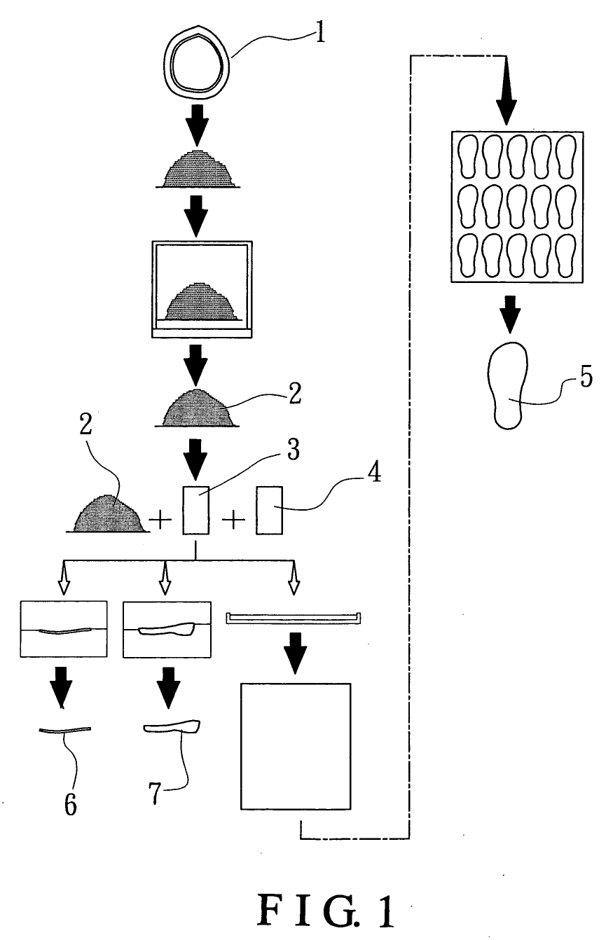

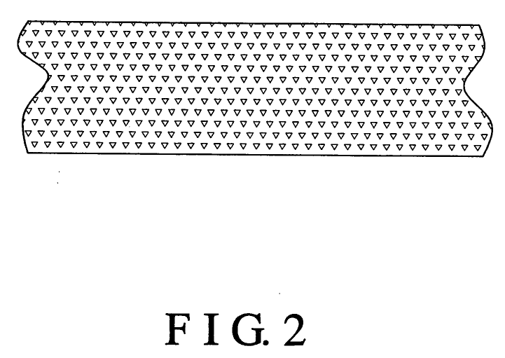

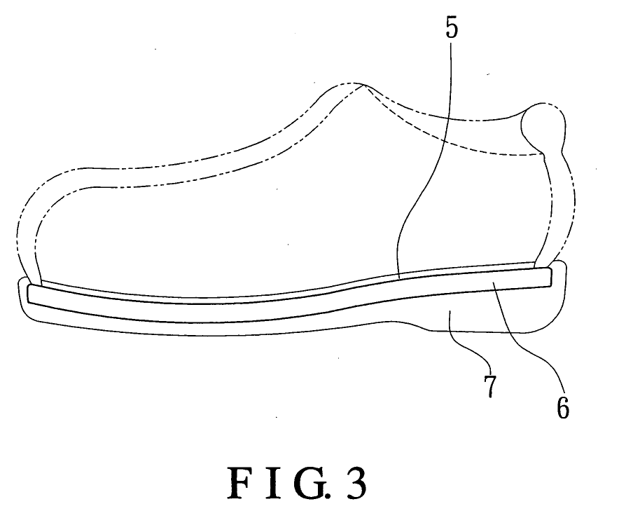

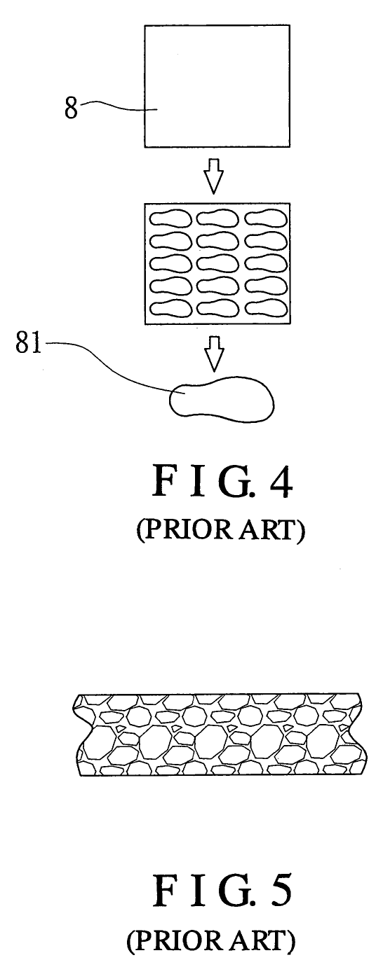

Referring to FIGS. 1 and 2, a preferred embodiment of a method for manufacturing environment friendly foam material for shoes includes the following steps:
(1) Acquiring materials: coconut shells 1 are used as the materials;
(2) Crushing the coconut shells 1: the coconut shells 1 are broken into small pieces;
(3) Grinding: the small pieces of coconut shells 1 are ground into coconut fiber powder 2 with a suitable fineness according to needs, which is between 50 and 400 meshes in size;
(4) Mixing: the coconut fiber powder 2 is mixed with glue 4 as well as foaming material 3, which can be TPR (thermoplastic resin), EVA (ethylene vinyl acetate), and ABS (copolymer of Acrylonitrile, Butadiene, and Styrene), such that the coconut fiber powder 2, and the foaming material 3 stick together;
(5) Foaming, in which the mixture of coconut fiber powder 2 and foaming material 3 is put into molds, and foams with air bubbles forming therein and thereon;
(6) Finishing, in which the foam mixture is cut into insoles 5 of shoes, and in which middle soles 6 and outsoles 7 of shoes are directly formed in those of the molds that are used for making middle soles and outsoles; thus, the middle soles 6, and the outsoles 7 are made.

In addition, the proportion of the coconut fiber powder 2 to the mixture of coconut fiber powder 2 and foaming material 3 is changed according to the kind of sole products to be manufactured, and ranges from 10% to 80%. In other words, different kinds of sole products have respective suitable flexibility and elasticity, and the proportion of the coconut fiber powder 2 to the mixture has to be adjusted accordingly.

From the above description, it can be easily understood that with the method of the present invention, insoles, middle soles, and outsoles of shoes can be manufactured, which are more resilient, and elastic, and easier to burn and decompose, and which will help provide more ventilation to the shoes, preventing fungus and dampness from forming in the shoes. Therefore, the foam material of shoes made in the present method is more environment friendly.

1. A method for manufacturing environment friendly foam material for shoes, comprising
a first step: acquiring materials; coconut shells being used as the materials;
a second step: crushing; the coconut shells being broken into small pieces;
a third step: grinding, in which the small pieces of coconut shells is ground into coconut fiber powder;
a fourth step: mixing, in which the coconut fiber powder is mixed with glue as well as foaming material such that the coconut fiber powder, and the foaming material stick together;
a fifth step: foaming, in which the mixture of coconut fiber powder and foaming material is made to foam in molds with air bubbles forming therein and thereon; and
a sixth step: finishing, in which the foam mixture is cut into insoles of shoes, and in which middle soles and outsoles of shoes are directly formed in those of the molds that are used for making middle soles and outsoles.

2. The method as claimed in claim 1, wherein in the third step, the coconut fiber powder has a fineness between 50 and 400 meshes.

3. The method as claimed in claim 1, wherein the proportion of the coconut fiber powder to the mixture is changed according to kinds of sole products to be manufactured, and ranges from 10% to 80% such that different kinds of sole products have respective elasticity.
